(19) United States
(12) Patent Application Publication
(10) Pub. No.: US 2007/0022657 A1
(43) Pub. Date: Feb. 1, 2007

(54) Exterior wall, permantly mounted flower pot

(76) Inventor: Herculano John Chavez, Rio Rancho, NM (US)

Correspondence Address: Herculano J. Chavez, 510 Stallion Rd. S.E., Rio Rancho, NM, 87124, US

(21) Appl. No.: 11/193,722

(22) Filed: Aug. 1, 2005

(51) Int. Cl. A01G 9/02

(52) U.S. Cl. 47/68

(57) ABSTRACT

Disclosed is a method of anchoring a properly designed flower pot to an exterior concrete, cement block, brick or stucco wall. The flower pot is made in a mold out of cement mortar and reinforced with number 9 wire that protrudes 1 ¼ inch out of the mounting surface of the flower pot and are used as anchor pins. To mount flowerpot on a wall, holes are drilled in the wall to match flower pot anchor pins. On unpainted wall surfaces cement mortar can be used between flower pot mounting surface and wall as a bonding agent an sealer. On painted wall surfaces epoxy, liquid nails, or silicon caulking can be used for bonding and sealer.

### BACKROUND OF INVENTION

The idea of permanent wall mounted flower pots started here three years ago when we purchased a home in Rio Rancho, N. Mex. The homes in this area are on fairly large lots, with five foot utility easements on each side of the property. Permanent structures, such as sidewalks, trees, shrubs, etc. are prohibited. You are left with a choice of lawn, gravel or dirt.

Two years ago I built some flower pots on a cement block fence. The pots received great comments from friends and neighbors, so I began to work on a way to pre-fabricate a flower pot that could be permanently mounted on a wall. The results are described in the description of the invention section of this application.

Lately I have looked at new homes that are being built here in New Mexico and elsewhere. New home developers are building beautiful homes on small lots with limited yard space. People purchasing these homes need all the ground space available for various reasons, i.e. children and pets. The wall mounted flower pots allow owners to plant various types of flowers and vegetation without taking up any of the limited space in their yard.

### BRIEF SUMMARY OF THE INVENTION

This wall mounted flower pot is unique, serviceable, and attractive. It has several advantages over conventional flower pots. For example, children cannot stumble over them while running and playing. Pets cannot jump in the pots and disturb the flowers or vegetation. The pots will not interfere with the lawn while it is being mowed or raked. And the pots dress up the utility easements without encroaching.

### DESCRIPTION OF DRAWING

FIG. 1 is the front view

FIG. 2 shows the surface and bottom of flower pots

FIG. 3 is the inside view, showing anchor pins as well

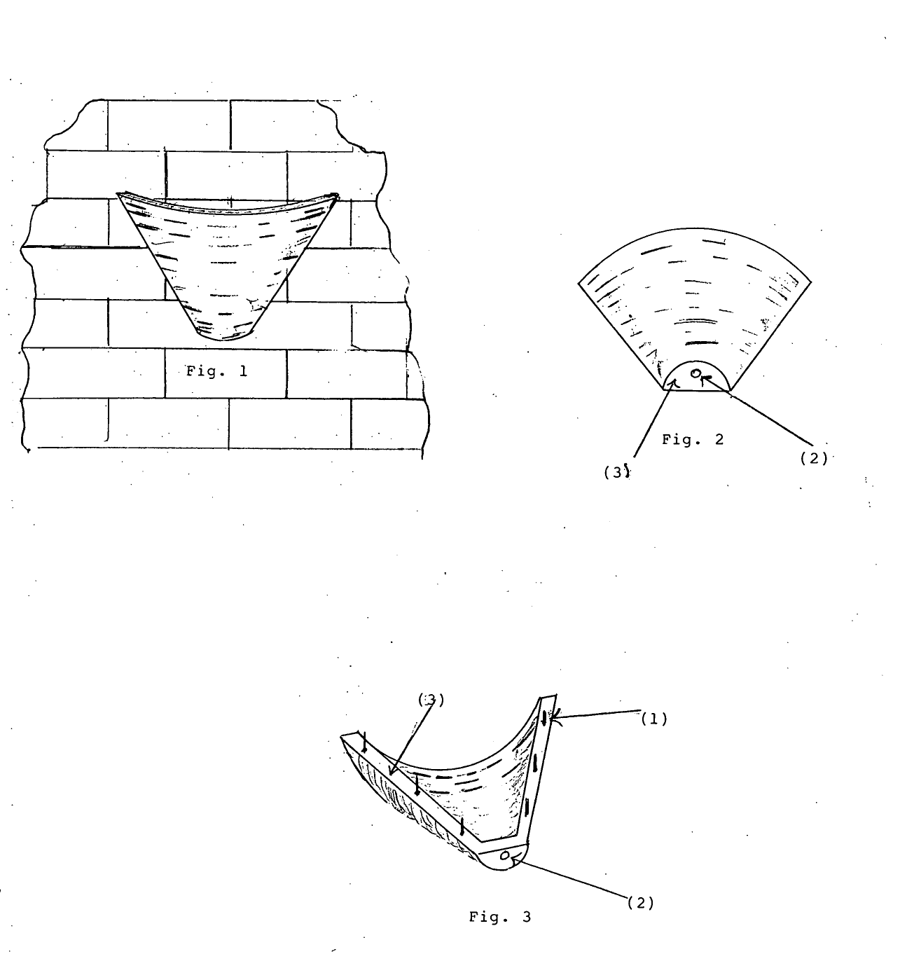

### DETAILED DESCRIPTION

The flower pot is half of a cone shaped container, with a flat bottom instead of a point and has a drain hole at the base. It is made of cement mortar cast in a mold and reinforced with number 9 wire that protrudes 1¼ inch out of the mounting surface of the pot and serves as the anchoring pins.

To mount on a wall, a template is made of pot anchor pins. Use template to mark anchor pin holes on the wall Using a masonry bit, drill the top two holes at 30-40 degree downward angle. This causes the top anchor pins to become hooks. The other holes are drilled straight in. On unpainted walls, cement mortar can be used to cement the pot to the wall. On a painted surface, epoxy, liquid nails, or silicon caulking can be used.

### PHOTOGRAPHS

Enclosed Photos Show the Following:

1. What utility easement and fence wall looked before installation.
2. What area looks like after installation.
3. Flower pot mounted on a brick wall using silicone caulking for bonding and sealer.

1. (canceled)

2. (canceled)

3. (canceled)

4. A flower pot for exterior vertical walls comprising a body having a semicircular flat, top opening and side walls having the same semicircular configuration, taper inward and down to a flat base that parallels the top surface of the body; said body has a drain hole and said body is one third in size of the top opening of the body; said body has an open back side with a flat mounting surface that contains the flower pot anchor pins; said body wall thickness is determined by the material used to reinforce flower pot body; said body is made of cement mortar and is reinforced with number nine gage wires and protrude from the mounting surface of the body and serve as anchoring pins; said flower pot body is held in-place permanently by inserting pot body anchor pins into matching holes drilled into a wall and cementing the pins and the entire mounting surface of the pot body, with mortar or any suitable bonding material
